(19) United States
(12) Patent Application Publication
(10) Pub. No.: US 2002/0157505 A1
(43) Pub. Date: Oct. 31, 2002

(54) Handle grip for a wrench

(76) Inventor: Chien-Kuo Wang, Taepei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/842,237

(22) Filed: Apr. 26, 2001

(51) Int. Cl. B25B 23/16

(52) U.S. Cl. 81/177.1

(57) ABSTRACT

A handle grip for a wrench includes a tubular body mounted to a shank of the wrench and a plurality of recesses are defined in the tubular body. The recesses extend toward a direction which is parallel with an axis of an object engaged by the wrench.

### FIELD OF THE INVENTION

The present invention relates to a handle grip for a wrench and the handle grip has recesses for the user's fingers to grasp. The recesses extend in parallel with a longitudinal axis of an object clamped by the wrench.

### BACKGROUND OF THE INVENTION

A conventional handle grip for a wrench is shown in FIG. 1 and generally is a cylindrical grip 100 on which no recesses are defined so that when the user grasps the grip 100, the user's fingers have no place to securely grasp the grip 100. Therefore, the user's hand could slip off from the grip 100 because of grease or oily liquid between the grip 100 and the user's hand. FIG. 2 shows an improved grip 101 in which recesses 102 are defined. However, the positions of the recesses 102 are not properly arranged so that when rotating the wrench, the fingers of the user tend to slip. It is, because that the recesses 102 extend in a direction which is perpendicular to an axis of an object or the engaging shaft 103 of the wrench.

The present invention intends to provide a handle grip having recesses which assist the firm grasp of the grip when rotating the wrench.

### SUMMARY OF THE INVENTION

In accordance with one aspect of the present invention, there is provided a handle grip for a wrench and comprising a tubular body mounted to a shank of the wrench and a plurality of recesses are defined in the tubular body. The recesses extend toward a direction which is parallel with an axis of an object engaged by the wrench.

The primary object of the present invention is to provide a handle grip for a wrench and the grip has recesses for the user's hand to grasp and will not slip when operating the wrench.

These and further objects, features and advantages of the present invention will become more obvious from the following description when taken in connection with the accompanying drawings which show, for purposes of illustration only, several embodiments in accordance with the present invention.

### BRIEF DESCRIPTION OF THE DRAWINGS

FIG. 1 is a perspective view to show a first conventional wrench and its handle grip;

FIG. 2 is a perspective view to show second first conventional wrench and its handle grip;

FIG. 3 is a perspective view to show a wrench and its handle grip of the present invention;

FIG. 4 is an exploded view to show the wrench and the handle grip of the present invention;

FIG. 5 is an illustrative view to show a user's hand grasping on the handle grip and rotating the wrench, and

FIGS. 6 and 7 respectively illustrate two type of wrenches with the handle grip of the present invention.

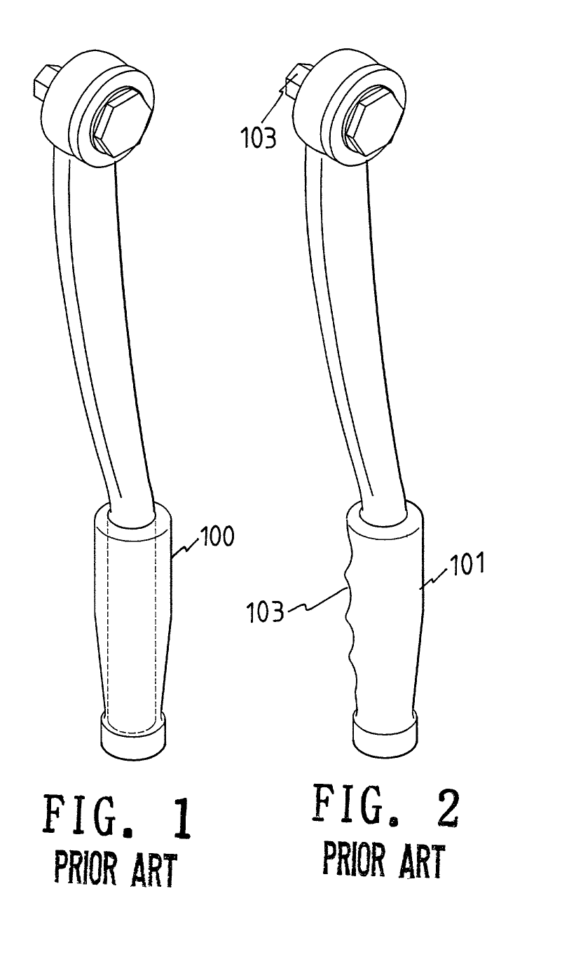

### DETAILED DESCRIPTION OF THE PREFERRED EMBODIMENT

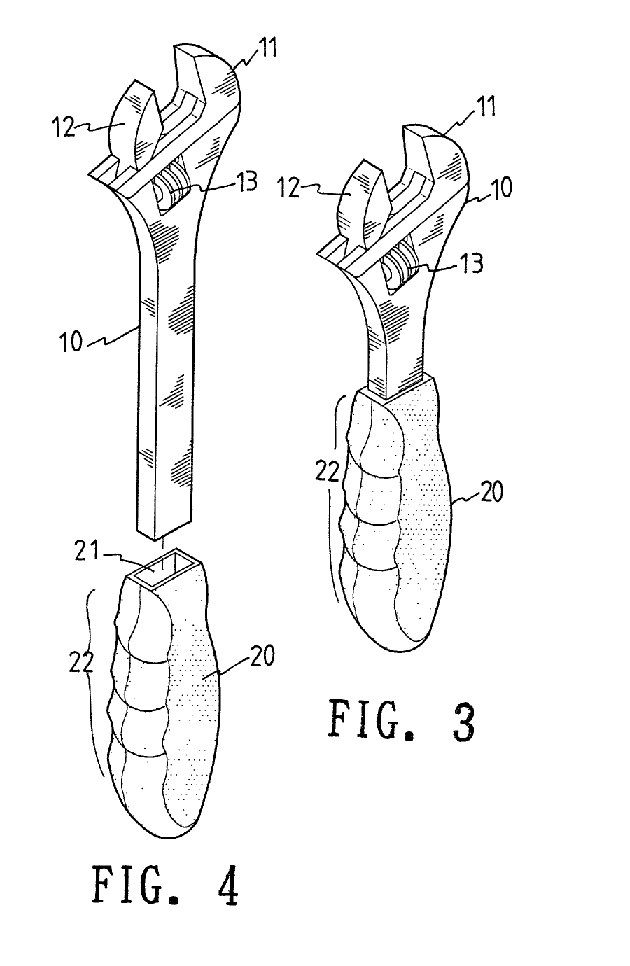

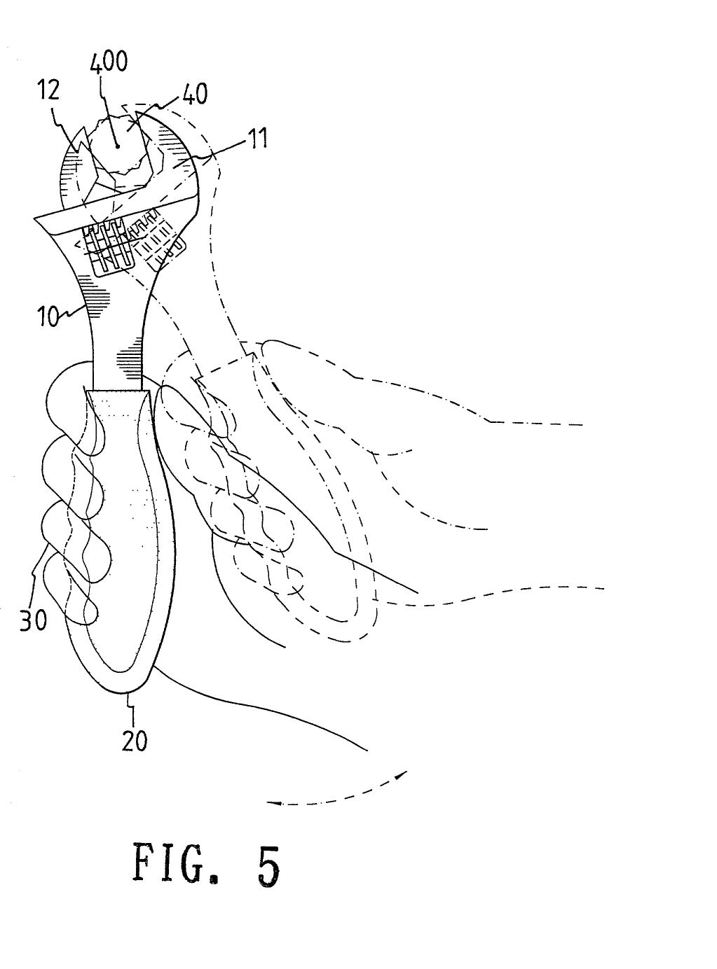

Referring to FIGS. 3 to 5, the handle grip of the present invention comprises a tubular body 20 which has an open end 21 for receiving a shank 10 of the wrench. In this embodiment, the wrench is an adjustable wrench and includes a fixed jaw 11 and a movable jaw 12. An adjustment screw 13 drives the movable jaw 12 to move in a groove toward or away from the fixed jaw 11. A plurality of recesses 22 are defined in the tubular body 20 and extend toward a direction which is parallel with an axis 400 of an object 40 engaged between the by the fixed jaw 11 and the movable jaw 12 as shown in FIG. 5. It is to be noted that the handle grip 20 is rotated about the axis 400 of the object 40 so that the fingers 30 of the user's hand move perpendicularly to the axis 400. In other words, the force of arm is the distance between the axis 400 and the fingers 30 and will no force be wasted.

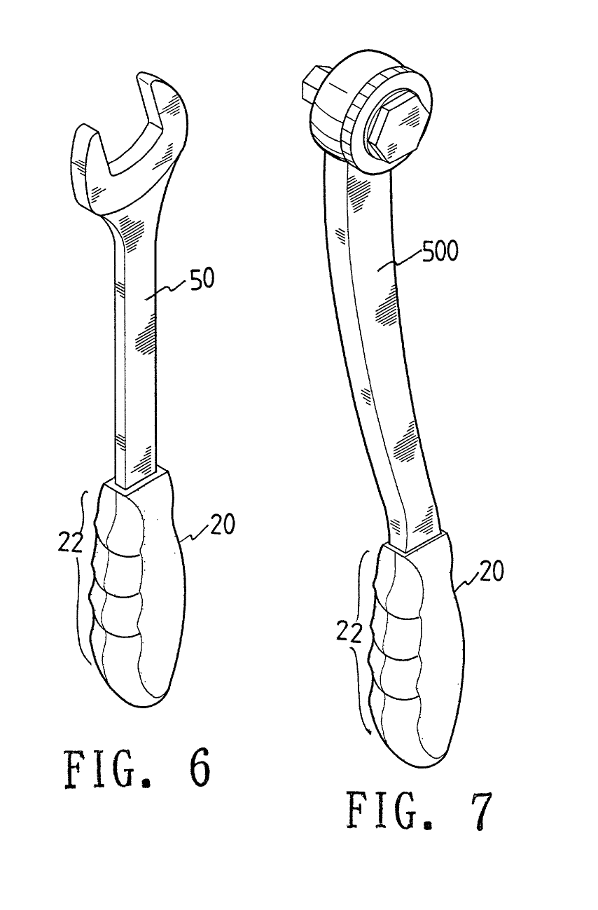

FIGS. 6 and 7 show that the handle grip 20 of the present invention may be used with different wrenches 50, 500, wherein the wrench 500 is a ratchet wrench.

While we have shown and described various embodiments in accordance with the present invention, it should be clear to those skilled in the art that further embodiments may be made without departing from the scope and spirit of the present invention.

What is claimed is:

1. A handle grip for a wrench, comprising:
a tubular body adapted to mounted to a shank of the wrench, a plurality of recesses defined in said tubular body and extending toward a direction which is adapted to be parallel with an axis of an object engaged by the wrench.

2. The handle grip as claimed in claim 1, wherein said tubular body has an open end defined in an end of said tubular body, said open end adapted to receive the shank of the wrench.
